(19) United States
(12) Patent Application Publication
(10) Pub. No.: US 2014/0212800 A1
(43) Pub. Date: Jul. 31, 2014

(54) ELECTROPHOTOGRAPHIC PHOTOSENSITIVE MEMBER, PROCESS CARTRIDGE AND ELECTROPHOTOGRAPHIC APPARATUS

(71) Applicant: CANON KABUSHIKI KAISHA, Tokyo (JP)

(72) Inventors: Daisuke Miura, Tokyo (JP); Daisuke Tanaka, Yokohama-shi (JP); Kazumichi Sugiyama, Numazu-shi (JP)

(73) Assignee: CANON KABUSHIKI KAISHA, Tokyo (JP)

(21) Appl. No.: 14/160,437

(22) Filed: Jan. 21, 2014

(30) Foreign Application Priority Data
Jan. 28, 2013 (JP) 2013-013510
Jan. 14, 2014 (JP) 2014-004387

(51) Int. Cl. G03G 15/00

(52) U.S. Cl. CPC G03G 5/047
USPC 430/56; 430/58.75; 399/159

(57) ABSTRACT

An electrophotographic photosensitive member, wherein a charge transporting layer is a surface layer, the charge transporting layer contains a specified charge transportable compound and a specified binder resin, and the charge transporting layer satisfies the following expression (4-1).

X_{P1}<X_{P5} (4-1)

### BACKGROUND OF THE INVENTION

1. Field of the Invention

The present invention relates to an electrophotographic photosensitive member, a process cartridge and an electrophotographic apparatus.

2. Description of the Related Art

As an electrophotographic photosensitive member to be mounted to an electrophotographic apparatus, an electrophotographic photosensitive member using an organic photoconductive substance (charge generating substance) is used. In particular, an electrophotographic photosensitive member is often used, which has a laminated type photosensitive member in which a charge generating layer and a charge transporting layer are laminated in this order.

As an electrophotographic apparatus repeatedly forms an image, the surface of an electrophotographic photosensitive member to be repeatedly used is directly subjected to electrical external forces such as charging, exposing, developing, transferring and cleaning, and thus the photosensitive member is demanded for having potential stability (suppression of potential change).

In regard to the problem of potential stability, Japanese Patent Application Laid-Open No. 2002-23395 and Japanese Patent Application Laid-Open No. 2009-186967 have proposed a method for enhancing the potential stability of an electrophotographic photosensitive member during repeated use, which includes incorporating a specified charge transporting substance into a charge transporting layer. However, when the specified charge transporting substance is used in a high-temperature and high-humidity environment, image deletion may easily occur.

The cause of the image deletion is considered as follows: dew on the surface of the electrophotographic photosensitive member and talc contained in a transfer material are adhered to the surface of the electrophotographic photosensitive member, and ozone and nitrogen oxide generated from a charging apparatus (hereinafter, also referred to as “charging products”) are also adhered thereto. These causes the reduction in the surface resistance of the surface of the electrophotographic photosensitive member, resulting in such a phenomenon that a latent image is blurred (image deletion).

In regard to the problem of suppression of image deletion, a method wherein a resin that easily wears is used for a surface layer (charge transporting layer) to thereby easily scrape off charging products adhered to the surface layer by cleaning has been proposed. Japanese Patent Application Laid-Open No. S62-160458 has proposed a method wherein a polycarbonate resin having a number average molecular weight of 1.5×10⁴ or less and a polycarbonate resin having a number average molecular weight of 4.5×10⁴ or more are incorporated into a charge transporting layer of an electrophotographic photosensitive member in a certain proportion or greater in terms of amount, thereby to make the surface layer easier to wear. Japanese Patent Application Laid-Open No. 2000-19765 has proposed a method wherein a charge transporting layer containing a polycarbonate resin or polyarylate resin having a molecular weight in a specified range and fluorine fine particles are used to thereby suppress image deletion due to application of alternating current.

As a result of studies by the present inventors, the electrophotographic photosensitive members described in Japanese Patent Application Laid-Open No. 2002-23395 and Japanese Patent Application Laid-Open No. 2009-186967 have room for improvement with respect to simultaneously satisfying potential stability and suppression of image deletion during the repeated use of the electrophotographic photosensitive member. With respect to the electrophotographic photosensitive members described in Japanese Patent Application Laid-Open No. S62-160458 and Japanese Patent Application Laid-Open No. 2000-19765, while the surface layer easily wears to thereby suppress the occurrence of image deletion, the thickness of the surface layer may vary to easily cause the reduction in potential stability. In addition, with respect to the electrophotographic photosensitive member described in Japanese Patent Application Laid-Open No. 2000-19765, the fluorine fine particles may easily cause the reduction in potential stability.

### SUMMARY OF THE INVENTION

An object of the present invention is to provide an electrophotographic photosensitive member having a charge transporting layer as a surface layer, which can achieve suppression of image deletion and potential change after repeated use at a high level. Another object of the present invention is to provide a process cartridge and an electrophotographic apparatus having the electrophotographic photosensitive member.

The present invention relates to an electrophotographic photosensitive member including a support, a charge generating layer formed on the support, and a charge transporting layer formed on the charge generating layer, wherein the charge transporting layer is a surface layer of the electrophotographic photosensitive member, the charge transporting layer contains: at least one charge transporting substance selected from the group consisting of a compound represented by the following formula (2) and a compound represented by the following formula (3), and at least one binder resin selected from the group consisting of a polycarbonate resin having a structural unit represented by the following formula (IA) and a polyester resin having a structural unit represented by the following formula (IB), and the charge transporting layer satisfies the following expression (4-1).

X_{P1}<X_{P5} (4-1)

In the expression (4-1),

X_{P1} represents the mass ratio (D/B) of the charge transporting substance (D) to the binder resin (B) based on IR spectroscopy measured at P1,

X_{P5} represents the mass ratio (D/B) of the charge transporting substance (D) to the binder resin (B) based on IR spectroscopy measured at P5,

P1 is the position on the surface of the charge transporting layer, and

P5 is the position where the distance from the surface of the charge transporting layer is 4T/5 when the thickness of the charge transporting layer is designated as T.

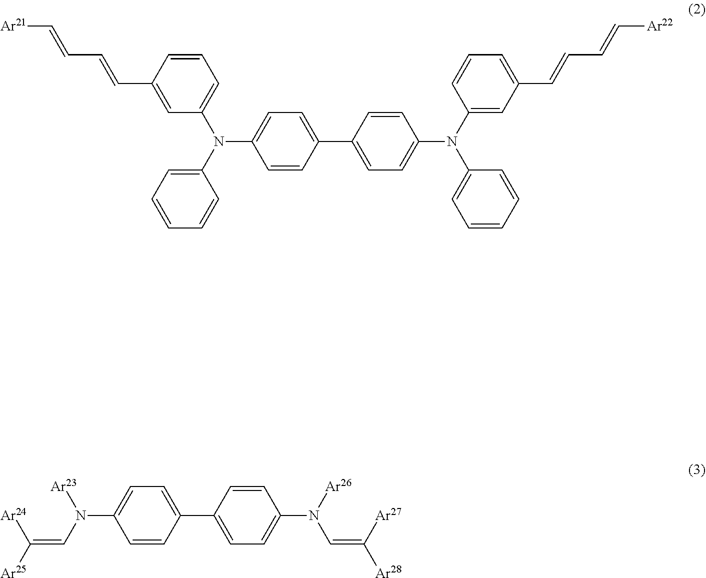

In the formula (2), Ar²¹ and Ar²² each independently represent a phenyl group or a phenyl group substituted with a methyl group, and in the formula (3), Ar²³ to Ar²⁸ each independently represent a phenyl group or a phenyl group substituted with a methyl group.

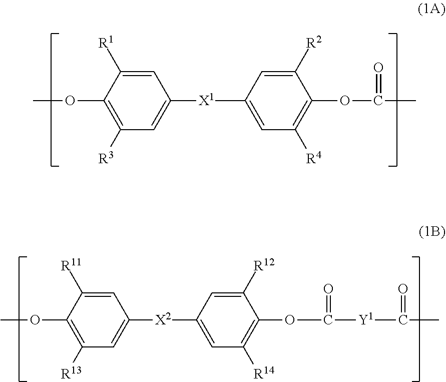

In the formula (IA), R¹ to R⁴ each independently represent a hydrogen atom, a methyl group or a phenyl group, and X¹ represents a single bond, an oxygen atom, a cyclohexylidene group or a bivalent group represented by the following formula (A).
In the formula (IB), R¹¹ to R¹⁴ each independently represent a hydrogen atom, a methyl group or a phenyl group, X² represents a single bond, an oxygen atom, a cyclohexylidene group or a bivalent group represented by the following formula (A), and Y¹ represents a meta-phenylene group, a para-phenylene group, a cyclohexylene group or a bivalent group represented by the following formula (B).

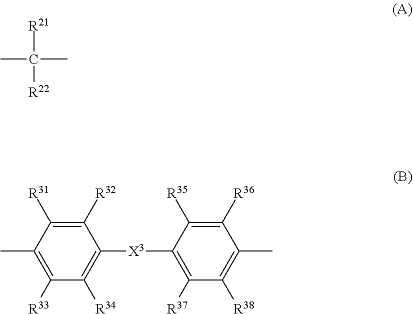

In the formula (A), R²¹ and R²² each independently represent a hydrogen atom, a methyl group, an ethyl group or a phenyl group, and in the formula (B), R³¹ to R³⁸ each independently represent a hydrogen atom, a methyl group or a phenyl group, and X³ represents a single bond, an oxygen atom, a sulfur atom or a methylene group.

The present invention also relates to a process cartridge detachably attachable to a main body of an electrophotographic apparatus, wherein the process cartridge integrally supports: the electrophotographic photosensitive member, and at least one device selected from the group consisting of a charging device, a developing device, a transferring device and a cleaning device.

The present invention also relates to an electrophotographic apparatus including the electrophotographic photosensitive member, a charging device, an exposure device, a developing device and a transfer device.

As described above, the present invention can provide an electrophotographic photosensitive member having a charge transporting layer as a surface layer, which achieves suppression of image deletion and potential change after repeated use at a high level, as well as a process cartridge and an electrophotographic apparatus.

Further features of the present invention will become apparent from the following description of exemplary embodiments with reference to the attached drawings.

### BRIEF DESCRIPTION OF THE DRAWINGS

FIG. 1 is a view illustrating one example of a schematic configuration of an electrophotographic apparatus provided with a process cartridge having an electrophotographic photosensitive member.

FIG. 2A and FIG. 2B are views illustrating one example of a layer configuration of an electrophotographic photosensitive member.

FIG. 3 is a diagram illustrating one example of a relationship between representative 2 points, X_{P2} and X_{P3}, in a charge transporting layer of an electrophotographic photosensitive member.

FIG. 4 is a diagram illustrating a positional relationship among 5 points in total, P1, P2, P3, P4 and P5, in a charge transporting layer of an electrophotographic photosensitive member.

### DESCRIPTION OF THE EMBODIMENTS

Preferred embodiments of the present invention will now be described in detail in accordance with the accompanying drawings.

The present invention is characterized in that the charge transporting layer satisfies the following expression (4-1):

X_{P1}<X_{P5} (4-1)

X_{P1} represents the mass ratio (D/B) of the charge transporting substance (D) to the binder resin (B) based on IR spectroscopy measured at P1,

X_{P5} represents the mass ratio (D/B) of the charge transporting substance (D) to the binder resin (B) based on IR spectroscopy measured at P5,

P1 is the position on the surface of the charge transporting layer (i.e. P1 is the position where the distance from the surface of the charge transporting layer is 0T/5=0 when the thickness of the charge transporting layer is designated as T), and

P5 is the position where the distance from the surface of the charge transporting layer is 4T/5 when the thickness of the charge transporting layer is designated as T.

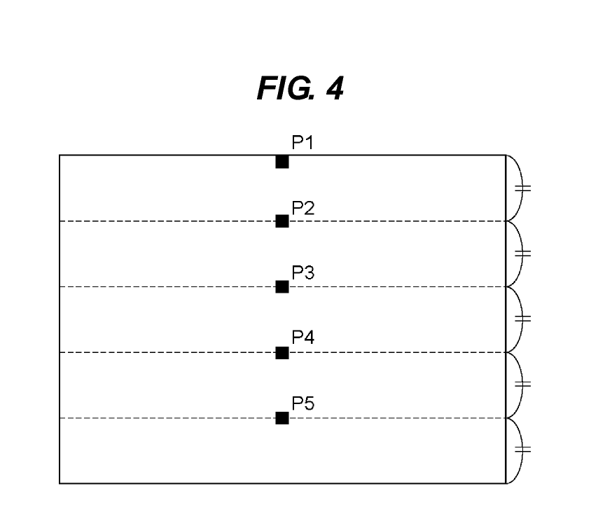

FIG. 4 is a diagram showing a positional relationship among 5 points in total, P1, P2, P3, P4 and P5, in the charge transporting layer of the electrophotographic photosensitive member. X_{P1} and X_{P5} are determined by measuring the mass ratio (D/B) of the charge transporting substance (D) to the binder resin (B) at each of 2 points, P1 and P5, among the 5 points.

The above characteristic means that the charge transporting layer (surface layer) has a structure in which the mass ratio of the charge transporting substance to the binder resin is increased (gradually increased) in the charge transporting layer nearer the support (the position of P5) as compared with the surface of the charge transporting layer (the surface of the electrophotographic photosensitive member). The present inventors presume the reason why suppression of image deletion and suppression of potential change are simultaneously achieved by the above characteristic as follows.

In general, the charge transporting substance serves to transport charge, and the binder resin contributes to wear resistance on the surface of the electrophotographic photosensitive member. The ratio of the binder resin is increased in the vicinity of the surface of the charge transporting layer to thereby increase the surface resistance of the surface of the charge transporting layer, thereby suppressing the occurrence of image deletion due to the repeated use of the electrophotographic photosensitive member.

In addition, the mass ratio of the binder resin is increased in the vicinity of the surface of the charge transporting layer to thereby enhance wear resistance (difficulty of wear). Then, the mass ratio of the charge transporting substance is increased in the charge transporting layer nearer the support (the vicinity of the interface with the charge generating layer: P5) to thereby effectively exert charge transporting ability. It is considered that the enhancement in wear resistance and the enhancement in charge transporting ability suppress the potential change after the repeated use of the electrophotographic photosensitive member more effectively.

The charge transporting layer in the present invention can satisfy the following expressions (4-2) to (4-5) to further suppressing the image deletion and the potential change.

X_{P1}<X_{P2} (4-2)

X_{P2}<X_{P3} (4-3)

X_{P3}<X_{P4} (4-4)

X_{P4}<X_{P5} (4-5)

In the expressions (4-2) to (4-5),

X_{P2} represents the mass ratio (D/B) of the charge transporting substance (D) to the binder resin (B) based on IR spectroscopy measured at P2,

X_{P3} represents the mass ratio (D/B) of the charge transporting substance (D) to the binder resin (B) based on IR spectroscopy measured at P3,

X_{P4} represents the mass ratio (D/B) of the charge transporting substance (D) to the binder resin (B) based on IR spectroscopy measured at P4,

P2 is the position where the distance from the surface of the charge transporting layer is T/5 when the thickness of the charge transporting layer is designated as T,

P3 is the position where the distance from the surface of the charge transporting layer is 2T/5 when the thickness of the charge transporting layer is designated as T, and

P4 is the position where the distance from the surface of the charge transporting layer is 3T/5 when the thickness of the charge transporting layer is designated as T.

When the expressions (4-2) to (4-5) are satisfied, a structure in which the mass ratio of the charge transporting layer to the binder resin is increased from the position of P1 to the position of P5 is made.

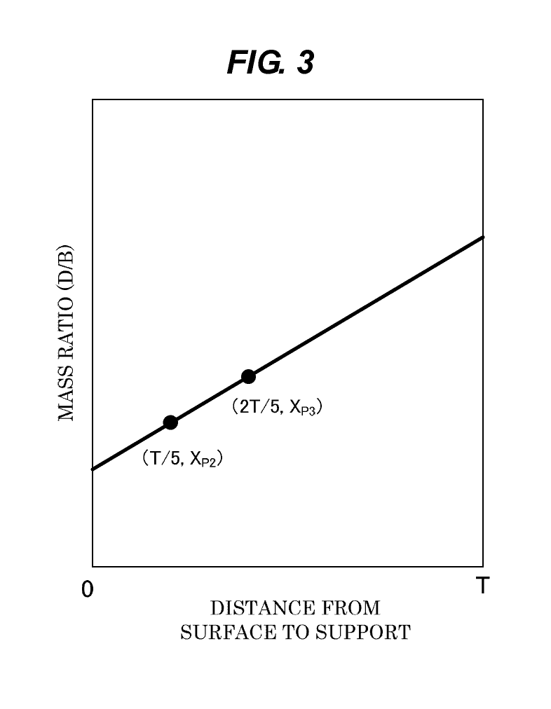

The concentration gradient of the charge transporting substance in the charge transporting layer can be the gradient described below, as shown in FIG. 3. Specifically, the charge transporting layer can satisfy the following expression (5):

0.020≦(X_{Pm+1}−X_{Pm})/(mT/5−(m−1)T/5)≦0.060 (5)

In the expression (5), m is an integer of 1 to 4. The expression (5) is the following expression (5-1) when m=1, the expression (5) is the following expression (5-2) when m=2, the expression (5) is the following expression (5-3) when m=3, and the expression (5) is the following expression (5-4) when m=4. In other words, the charge transporting layer satisfies the expressions (5-1) to (5-4).

0.020≦(X_{P2}−X_{P1})/(T/5−0)≦0.060 (5-1)

0.020≦(X_{P3}−X_{P2})/(2T/5−T/5)≦0.060 (5-2)

0.020≦(X_{P4}−X_{P3})/(3T/5−2T/5)≦0.060 (5-3)

0.020≦(X_{P5}−X_{P4})/((4T/5−3T/5)≦0.060 (5-4)

The slope of the concentration gradient of the charge transporting substance from the surface of the charge transporting layer to the charge transporting layer nearer the support can be in the range of the expression (5) because the image deletion and the potential change after the repeated use of the electrophotographic photosensitive member are further suppressed.

Charge Transporting Layer

The charge transporting layer of the electrophotographic photosensitive member of the present invention contains the charge transporting substance and the binder resin. The charge transporting layer contains as the charge transporting substance, at least one charge transporting substance selected from the group consisting of compounds represented by the following formula (2) and the following formula (3). The charge transporting layer contains as the binder resin, at least one binder resin selected from the group consisting of a polycarbonate resin having a structural unit represented by the following formula (IA) and a polyester resin having a structural unit represented by the following formula (IB).

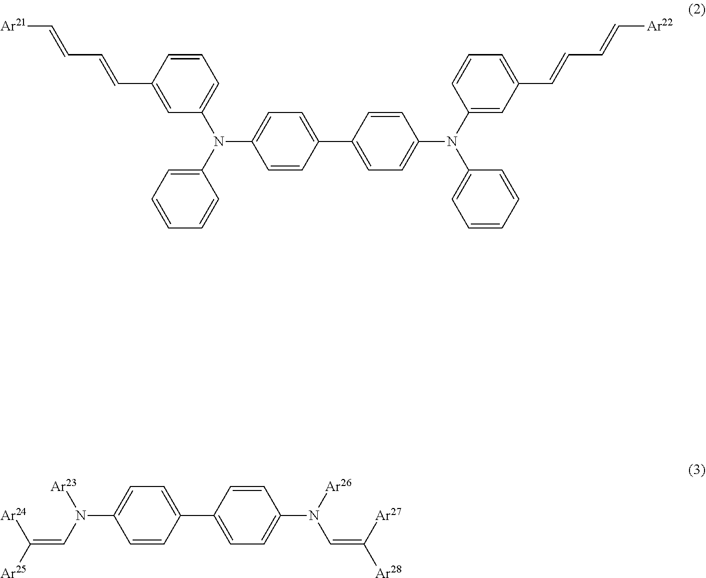

In the formula (2), Ar²¹ and Ar²² each independently represent a phenyl group or a phenyl group substituted with a methyl group. In the formula (3), Ar²³ to Ar²⁸ each independently represent a phenyl group or a phenyl group substituted with a methyl group.

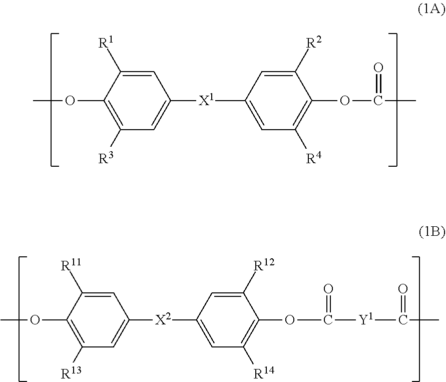

In the formula (IA), R¹ to R⁴ each independently represent a hydrogen atom, a methyl group or a phenyl group, and X¹ represents a single bond, an oxygen atom, a cyclohexylidene group or a bivalent group represented by the following formula (A).

In the formula (1B), R¹¹ to R¹⁴ each independently represent a hydrogen atom, a methyl group or a phenyl group, X² represents a single bond, an oxygen atom, a cyclohexylidene group or a bivalent group represented by the following formula (A), and Y¹ represents a meta-phenylene group, a para-phenylene group, a cyclohexylene group or a bivalent group represented by the following formula (B).

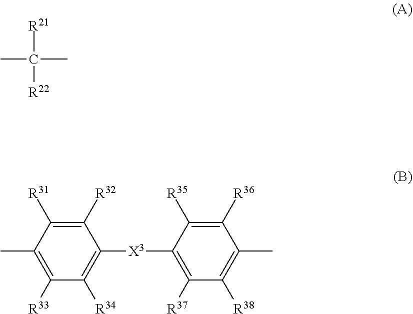

In the formula (A), R²¹ and R²² each independently represent a hydrogen atom, a methyl group, an ethyl group or a phenyl group.
In the formula (B), R³¹ to R³⁸ each independently represent a hydrogen atom, a methyl group or a phenyl group, and X³ represents a single bond, an oxygen atom, a sulfur atom or a methylene group.

The mass ratio (D/B) of the charge transporting substance (D) to the binder resin (B) is measured by IR spectroscopy, and an IR (IR spectral) apparatus is used. For example, a Fourier transform IR spectral (FT-IR) apparatus is used.

The charge transporting layer satisfying the expressions (4-1) to (4-5) is formed by drying a coat of a charge-transporting-layer coating liquid containing the charge transporting substance, the binder resin, and the following first solvent and second solvent. Additionally, when the solubility of the charge transporting substance in 100 g of the first solvent in an environment at 23° C. under 1 atmosphere is designated as Y1(g), and the solubility of the charge transporting substance in 100 g of the second solvent in an environment at 23° C. under 1 atmosphere is designated as Y2(g), solubility Y1 and solubility Y2 satisfy the following expression (6).

Y1>Y2 (6)

The first solvent is at least one selected from the group consisting of toluene, xylene, ethylbenzene and mesitylene. Herein, xylene has a boiling point of 138 to 144° C., toluene has a boiling point of 110.6° C., ethylbenzene has a boiling point of 136° C., and mesitylene has a boiling point of 165° C.

The second solvent is a compound having a higher boiling point under 1 atmosphere than the first solvent. The compound having a higher boiling point under 1 atmosphere than the first solvent is, for example, a compound having a higher boiling point under 1 atmosphere than toluene when the first solvent contains only toluene, or a compound having a higher boiling point under 1 atmosphere than xylene when the first solvent contains only xylene. When the first solvent is a mixed solvent, the compound is a compound having a higher boiling point than a compound whose boiling point is the highest in the mixed solvent. For example, when xylene and toluene are used, a compound having a higher boiling point under 1 atmosphere than xylene corresponds to the second solvent.

Examples of a solvent as a candidate of the second solvent include dibutyl ether (boiling point: 142° C.), di-n-hexyl ether (boiling point: 227° C.), butyl phenyl ether (boiling point: 210.2° C.), anisole (boiling point: 154° C.), phenetole (boiling point: 172° C.), 4-methylanisole (boiling point: 174° C.), ethyl benzyl ether (boiling point: 186° C.), diphenyl ether (boiling point: 259° C.), dibenzyl ether (boiling point: 297° C.), 1,4-dimethoxybenzene (boiling point: 213° C.), cineol (boiling point: 176° C.), 1,2-dibutoxyethane (boiling point: 203° C.), diethylene glycol dimethyl ether (boiling point: 162° C.), diethylene glycol ethyl methyl ether (boiling point: 179° C.), ethylene glycol diethyl ether (boiling point: 189° C.), triethylene glycol dimethyl ether (boiling point: 216° C.), dipropylene glycol dimethyl ether (boiling point: 175° C.), diethylene glycol diethyl ether (boiling point: 188° C.), diethylene glycol dibutyl ether (boiling point: 256° C.), 1-hexanol (boiling point: 158° C.), 1-heptanol (boiling point: 176° C.), cyclohexanol (boiling point: 161° C.), benzyl alcohol (boiling point: 205° C.), ethylene glycol (boiling point: 197.3° C.), 1,4-butanediol (boiling point: 230° C.), 1,5-pentanediol (boiling point: 242° C.), diethylene glycol (boiling point: 244.3° C.), 2-heptanone (boiling point: 151.5° C.), 4-heptanone (boiling point: 143.7° C.), acetylacetone (boiling point: 140.4° C.), diisobutyl ketone (boiling point: 163° C.), acetonylacetone (boiling point: 191° C.), phorone (boiling point: 198° C.), acetophenone (boiling point: 202° C.), isophorone (boiling point: 215.3° C.), cyclohexanone (boiling point: 155.6° C.), methylcyclohexanone (boiling point: 169° C.), benzyl acetate (boiling point: 212° C.), pentyl acetate (boiling point: 149.2° C.), isopentyl acetate (boiling point: 142.1° C.), 3-methoxybutyl acetate (boiling point: 172° C.), 2-ethylbutyl acetate (boiling point: 160° C.), 2-ethylhexyl acetate (boiling point: 198.6° C.), cyclohexyl acetate (boiling point: 172° C.), benzyl acetate (boiling point: 215.5° C.), methyl benzoate (boiling point: 199.6° C.), ethyl benzoate (boiling point: 212° C.), butyl propionate (boiling point: 146.8° C.), isopentyl propionate (boiling point: 160.7° C.), butyl butyrate (boiling point: 166.6° C.), isopentyl butyrate (boiling point: 184.8° C.), diethyl oxalate (boiling point: 188.5° C.), diethyl malonate (boiling point: 199.3° C.), dimethyl phthalate (boiling point: 283° C.), methyl salicylate (boiling point: 222° C.), ethyl 3-ethoxypropionate (boiling point: 166° C.), ethylene glycol monomethyl ether acetate (boiling point: 145° C.), ethylene glycol monoethyl ether acetate (boiling point: 156.3° C.), propylene glycol monomethyl ether acetate (boiling point: 146° C.), ethylene glycol monobutyl ether acetate (boiling point: 192° C.), ethylene glycol monohexyl ether acetate (boiling point: 208.3° C.), diethylene glycol monoethyl ether acetate (boiling point: 217.4° C.), γ-butyrolactone (boiling point: 204° C.), ethylene carbonate (boiling point: 260.7° C.), propylene carbonate (boiling point: 240° C.), cumene (boiling point: 152.4° C.), tetralin (boiling point: 207.5° C.), butylbenzene (boiling point: 183.3° C.), t-butylbenzene (boiling point: 169° C.), p-cymene (boiling point: 177.1° C.), cyclohexylbenzene (boiling point: 238.9° C.), o-diethylbenzene (boiling point: 183.5° C.), pentylbenzene (boiling point: 205° C.), dodecylbenzene (boiling point: 288° C.), nonane (boiling point: 150.8° C.), decane (boiling point: 174.2° C.), N-methylpyrrolidone (boiling point: 202° C.), nitrobenzene (boiling point: 210.9° C.) and sulfolane (boiling point: 285° C.)

The second solvent is selected from the compounds so that the above expression relating to the relationship between solubility Y1 and solubility Y2 is satisfied.

Preferably, examples of the solvent as a candidate of the second solvent include hexanol, heptanol, cyclohexanol, benzyl alcohol, ethylene glycol, 1,4-butanediol, 1,5-pentanediol, diethylene glycol, diethylene glycol ethyl methyl ether, ethylene carbonate, propylene carbonate, nitrobenzene, pyrrolidone, N-methylpyrrolidone, methyl benzoate, ethyl benzoate, benzyl acetate, ethyl 3-ethoxypropionate, acetophenone, methyl salicylate, dimethyl phthalate and sulfolane.

The charge transporting layer is formed by drying the coat of the charge-transporting-layer coating liquid containing the first solvent and the second solvent, and thus the ratio of the charge transporting substance to the binder resin is changed in the thickness direction and the charge transporting layer has the concentration gradient of the charge transporting substance in the thickness direction. The present inventors presume as follows with respect to the reason why the charge transporting layer has the concentration gradient of the charge transporting substance in the thickness direction.

In the step of drying the coat of the charge-transporting-layer coating liquid, heat from the support is conducted from the support (the interface with the charge generating layer) to the coat, and thus a solvent of the coat in the vicinity of the support vaporizes. It is considered that since the first solvent has a lower boiling point than the second solvent, the first solvent preferentially vaporizes by heating in the coat nearer the support. In the present invention, solubility Y1 of the charge transporting substance in the first solvent is higher than solubility Y2 of the charge transporting substance in the second solvent. Accordingly, it is considered that if the first solvent preferentially vaporizes by heating as compared with the second solvent, the amount of the first solvent in the coat is reduced as compared with the amount of the second solvent in the coat nearer the support. As a result, it is considered that the charge transporting substance that cannot be completely dissolved is precipitated in the coat nearer the support.

As the drying of the coat further progresses, the charge transporting layer is formed while the solid content concentration of the coat being increased over time. In addition, the content rate of the first solvent in the coat on the process of drying is gradually lowered. As a result, as the content rate of the first solvent is reduced over time, the charge transporting substance is precipitated. The present inventors consider that the continuous change in the ratio of the first solvent to the second solvent and the difference between the solubility of the charge transporting substance in the first solvent and the solubility thereof in the second solvent are utilized to thereby enable the concentration of the charge transporting substance in the charge transporting layer to have a gradient. Herein, the difference between the solubility of the binder resin, namely, the polycarbonate resin and/or polyester resin, in the first solvent and the solubility thereof in the second solvent is relatively lower than the difference between the solubility of the charge transporting substance in the first solvent and the solubility thereof in the second solvent. Therefore, it is considered that the charge transporting layer having the concentration gradient of the charge transporting substance in the thickness direction thereof is formed by the difference between the solubility of the charge transporting substance in the first solvent and the solubility thereof in the second solvent.

The content of the first solvent can be higher than the content of the second solvent in the charge-transporting-layer coating liquid because it brings satisfying the suppression of image deletion and the potential stability after repeated use simultaneously at high levels.

Charge Transporting Substance

The charge transporting substance is the compound represented by the formula (2) and/or the compound represented by the formula (3). Specific examples of the charge transporting substance are shown below.

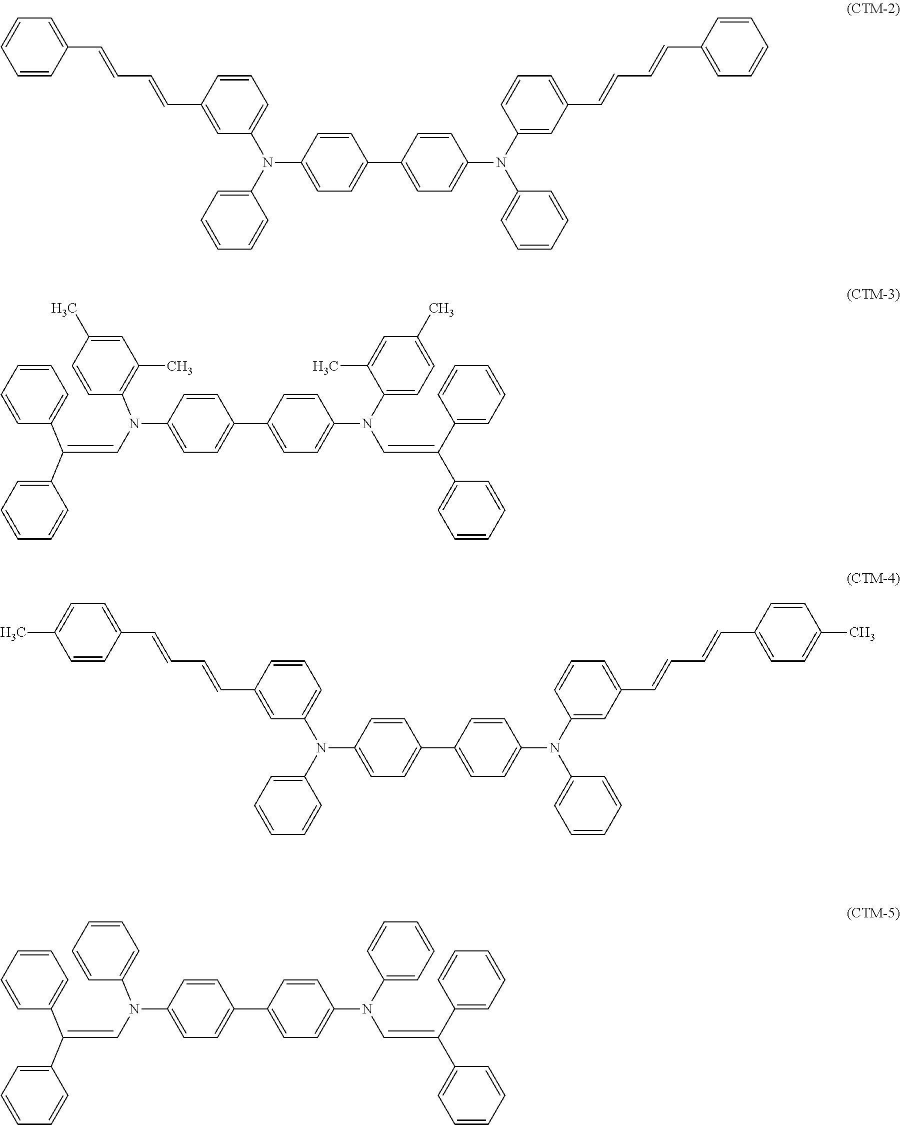

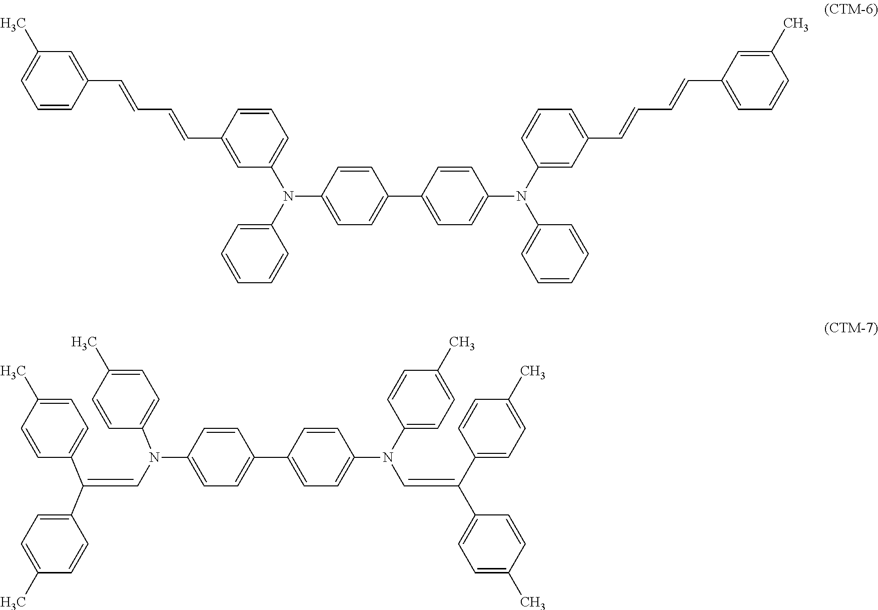 [SMILES: Cc1cccc(/C=C/C=C/c2cccc(N(c3ccccc3)c3ccc(-c4ccc(N(c5ccccc5)c5cccc(/C=C/C=C/c6cccc(C)c6)c5)cc4)cc3)c2)c1 ; Cc1ccc(C(=CN(c2ccc(C)cc2)c2ccc(-c3ccc(N(C=C(c4ccc(C)cc4)c4ccc(C)cc4)c4ccc(C)cc4)cc3)cc2)c2ccc(C)cc2)cc1]

The charge transporting substance is selected from among the compounds in consideration of the relationship of Y1>Y2. The charge transporting substance for use in the present invention may be only one compound, or may be two or more compounds.

Binder Resin

The binder resin is at least one selected from the group consisting of the polycarbonate resin having the structural unit represented by the formula (IA) and the polyester resin having the structural unit represented by the formula (IB).

Specific examples of the structural unit of the polycarbonate resin having the structural unit represented by the formula (IA) are shown below.

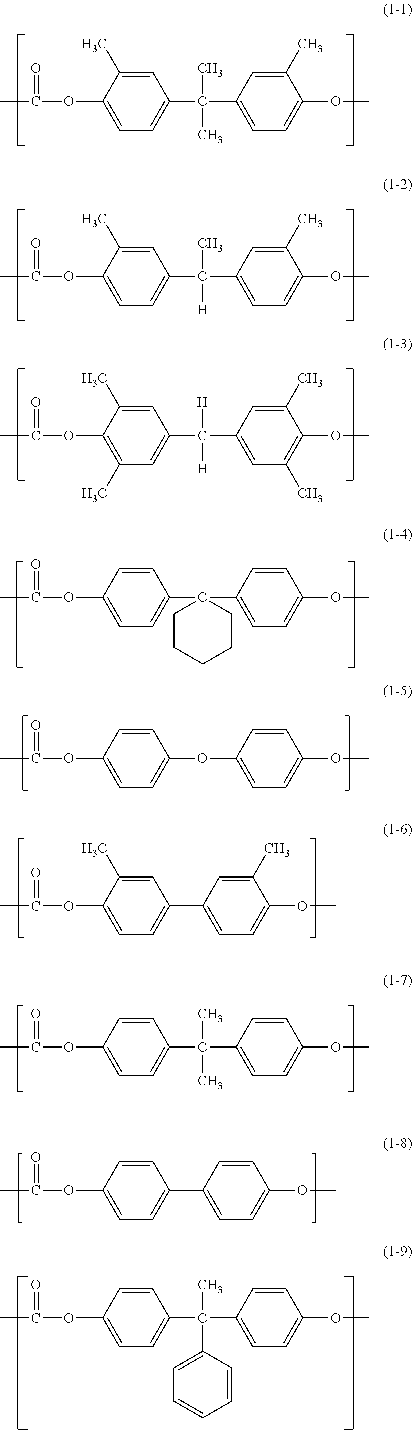

In particular, the structural unit can be a structural unit represented by any of the formulae (1-1), (1-2), (1-4) and (1-5). In addition, one of the structural units can be used singly, or two or more of the structural units can be used as a mixture or a copolymer. The copolymerization form may be any of block copolymerization, random copolymerization and alternating copolymerization.

Specific examples of the structural unit of the polyester resin having the structural unit represented by the formula (IB) are shown below.

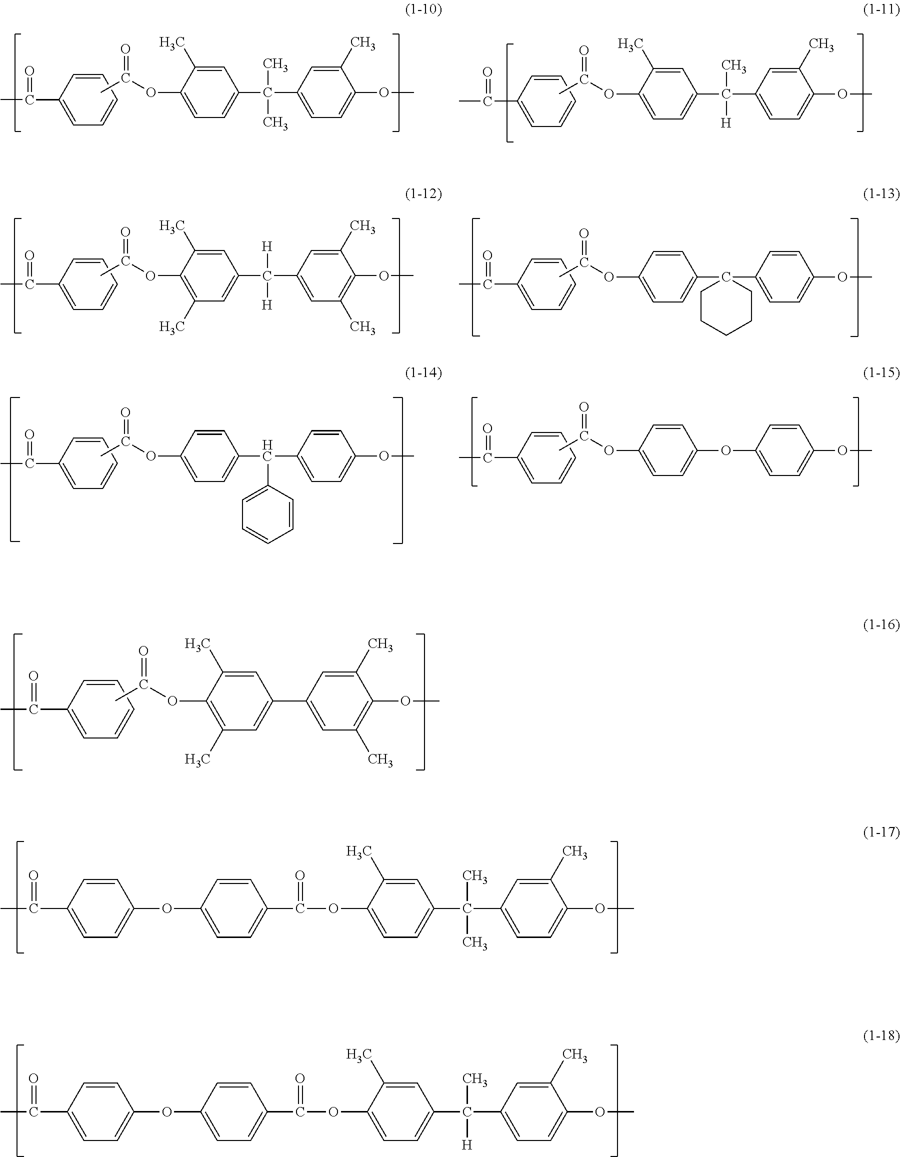

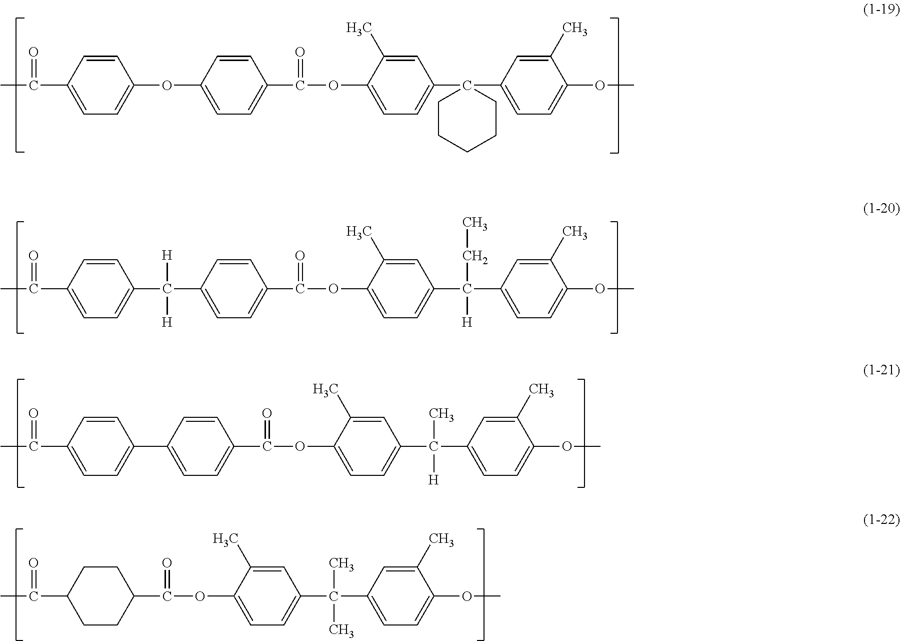

In particular, the structural unit can be a structural unit represented by any of the formulae (1-10), (1-11), (1-12), (1-15), (1-16), (1-17) and (1-18). In addition, one of the structural units can be used singly, or two or more of the structural units can be used as a mixture or a copolymer. The copolymerization form may be any of block copolymerization, random copolymerization and alternating copolymerization.

The polycarbonate resin having the structural unit represented by the formula (IA) and the polyester resin having the structural unit represented by the formula (1B) can be free of a siloxane structure. In addition, the charge transporting layer can be free of any polycarbonate resins having a siloxane structure and any polyester resins having a siloxane structure. The siloxane structure is a structure having silicon atoms constituting a siloxane moiety at each of both ends and groups connected thereto, as well as an oxygen atom, a silicon atom and groups connected thereto sandwiched between the silicon atoms at each of both ends. Specifically, the siloxane structure means a structure in a frame of a dashed line indicated in the following formula (D-S). In the formula (D-S), symbol a denotes the number of repetitions of the structure in brackets, and the average value of symbol a in the resin is 1 or more and 500 or less.

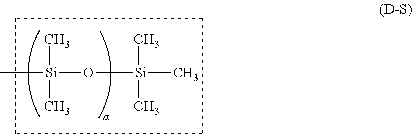

The polycarbonate resin having the structural unit represented by the formula (IA) and the polyester resin having the structural unit represented by the formula (IB) can be synthesized by a known method. The polycarbonate resin can be synthesized by a phosgene method or a transesterification method. The polyester resin can be synthesized by, for example, the method described in Japanese Patent Application Laid-Open No. 2007-047655 or Japanese Patent Application Laid-Open No. 2007-72277. The weight average molecular weights of the polycarbonate resin and the polyester resin are preferably 20,000 or more and 300,000 or less, and more preferably 50,000 or more and 200,000 or less.

In the present invention, the weight average molecular weight of the resin is a weight average molecular weight in terms of polystyrene measured according to the method described in Japanese Patent Application Laid-Open No. 2007-79555 with an ordinary method.

The charge-transporting-layer coating liquid may further contain a compound having a boiling point under 1 atmosphere of 35 to 70° C. By containing a compound having a lower boiling point than the first solvent and the second solvent as described above, the compound preferentially vaporizes at the initial stage of drying of the coat of the charge-transporting-layer coating liquid and heat exchange (endotherm) occurs in the vicinity of the surface of the charge transporting layer to increase the mass ratio of the resin. It is thus considered that the expression (5) can be in the range of the slope. The compound having a boiling point under 1 atmosphere of 35 to 70° C. can be acetone (boiling point: 56.5° C.), diethyl ether (boiling point: 35° C.), methyl acetate (boiling point: 56.9° C.), tetrahydrofuran (boiling point: 66° C.) or dimethoxymethane (boiling point: 42° C.)

The charge transporting layer may contain an additive. Examples of the additive include the following compounds (antioxidants). Herein, t-Bu represents a tert-butyl group.

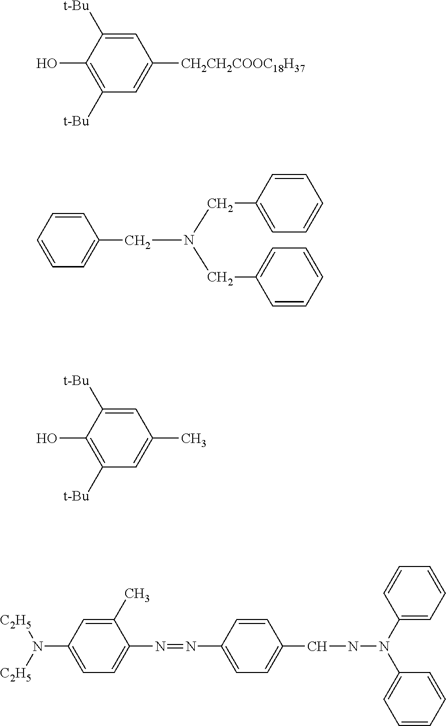

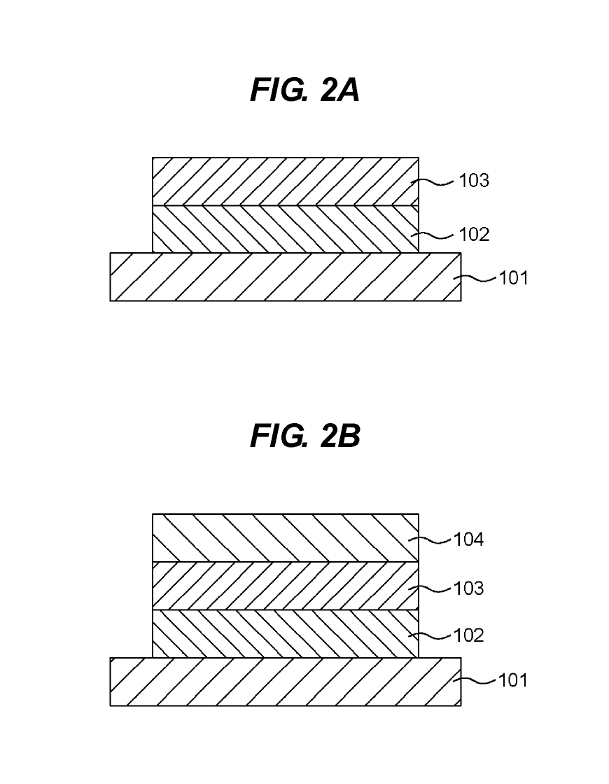

Now, the configuration of the electrophotographic photosensitive member will be described. The electrophotographic photosensitive member of the present invention includes a support, a charge generating layer formed on the support, and a charge transporting layer formed on the charge generating layer, the charge transporting layer being a surface layer. The charge transporting layer may have a laminated structure, and in the case, the charge transporting layer as the surface layer has the concentration gradient of the charge transporting substance. FIG. 2A and FIG. 2B are views illustrating one example of a layer configuration of the electrophotographic photosensitive member. In FIG. 2A and FIG. 2B, reference number 101 represents a support, reference number 102 represents a charge generating layer, reference number 103 represents a charge transporting layer (first charge transporting layer), and reference number 104 represents a second charge transporting layer.

Support

The support can be one having conductivity (conductive support). For example, a support made of a metal such as aluminum, aluminum alloy or stainless can be used. When the support is a support made of aluminum or an aluminum alloy, an ED tube, an EI tube, or a support obtained by subjecting the ED tube or the EI tube to cutting, electrolytic composite polishing (electrolysis by an electrode having an electrolysis function and an electrolyte solution, and polishing by a grinding stone having a polishing function), or wet or dry honing treatment can also be used. A metal support having a layer on which a covering film is formed by vapor deposition of aluminum, an aluminum alloy or an indium oxide-tin oxide alloy, or a resin support can also be used.

A support in which conductive particles such as carbon black, tin oxide particles, titanium oxide particles or silver particles are impregnated with a resin, or a plastic having a conductive binder resin can also be used.

The surface of the support may be subjected to cutting treatment, roughening treatment or alumite treatment in order to suppress an interference pattern due to scattering of laser light or the like.

When the surface of the support is a layer provided in order to impart conductivity, the volume resistivity of the layer is preferably 1×10¹° Ω·cm or less and particularly preferably 1×10⁶ Ω·cm or less.

In the electrophotographic photosensitive member, a conductive layer may be provided on the support in order to suppress an interference pattern due to scattering of laser light or the like and cover scratch on the support. The conductive layer is a layer formed by drying a coat of a conductive-layer coating liquid in which the conductive particles are dispersed in the binder resin.

Examples of the conductive particles include carbon black, acetylene black, powders of metals such as aluminum, nickel, iron, Nichrome, copper, zinc and silver, and powders of metal oxides such as conductive tin oxide and ITO.

Examples of the binder resin include a polyester resin, a polycarbonate resin, a polyvinyl butyral resin, an acrylic resin, a silicone resin, an epoxy resin, a melamine resin, a urethane resin, phenolic resin and an alkyd resin.

Examples of the solvent of the conductive-layer coating liquid include an ether-based solvent, an alcohol-based solvent, a ketone-based solvent and an aromatic hydrocarbon solvent.

The thickness of the conductive layer is preferably 0.2 μm or more and 40 μm or less, more preferably 1 μm or more and 35 μm or less, and further preferably 5 μm or more and 30 μm or less.

An undercoat layer may be provided between the support or the conductive layer and the charge generating layer. The undercoat layer can be formed by applying a coat of an undercoat-layer coating liquid containing a binder resin on the support or the conductive layer, and drying or curing the coat.

Examples of the binder resin of the undercoat layer include polyacrylic acids, methylcellulose, ethylcellulose, a polyamide resin, a polyimide resin, a polyamide-imide resin, a polyamide acid resin, a melamine resin, an epoxy resin and a polyurethane resin. The binder resin for use in the undercoat layer can be a thermoplastic resin. Specifically, the binder resin can be a thermoplastic polyamide resin. The polyamide resin can be low crystalline or non-crystalline copolymerized nylon that can be applied in the state of solution.

The thickness of the undercoat layer is preferably 0.05 μm or more and 40 μm or less, more preferably 0.05 μm or more and 7 μm or less, and further preferably 0.1 μm or more and 2 μm or less.

In addition, in order that the flow of charge (carrier) is not disrupted in the undercoat layer, the undercoat layer may contain semiconductive particles or an electron transporting substance (electron-accepting substance such as acceptor).

Charge Generating Layer

The charge generating layer is formed on the support, the conductive layer or the undercoat layer.

Examples of the charge generating substance for use in the electrophotographic photosensitive member include an azo pigment, a phthalocyanine pigment, an indigo pigment and a perylene pigment. The charge generating substance for use in the present invention may be made of only one compound, or may be made of two or more compounds. The compound that is preferably used as the charge generating substance can be oxytitamium phthalocyanine, hydroxygallium phthalocyanine, chlorogallium phthalocyanine or the like from the viewpoint of a high sensitivity.

Examples of the binder resin for use in the charge generating layer include a polycarbonate resin, a polyester resin, a butyral resin, a polyvinyl acetal resin, an acrylic resin, a vinyl acetate resin and a urea resin. Among the binder resins, a resin other than a polycarbonate resin and a polyester resin is preferable in view of the coating ability of the charge-transporting-layer coating liquid, and in particular, a butyral resin is more preferable. One of the resins can be used singly, or two or more of the resins can be used as a mixture or a copolymer.

The charge generating layer can be formed by forming a coat of a charge-generating-layer coating liquid obtained by dispersing the charge generating substance together with the binder resin and the solvent, and drying the coat. In addition, the charge generating layer may be a vapor deposition film of the charge generating substance.

Examples of the dispersing method include methods using a homogenizer, ultrasonic wave, a ball mill, a sand mill, Attritor or a roll mill.

The ratio of the charge generating substance to the binder resin is preferably in a range from 1:10 to 10:1 (mass ratio) and particularly preferably in a range from 1:1 to 3:1 (mass ratio).

Examples of the solvent for use in the charge-generating-layer coating liquid include an alcohol-based solvent, a sulfoxide-based solvent, a ketone-based solvent, an ether-based solvent, an ester-based solvent or an aromatic hydrocarbon solvent.

The thickness of the charge generating layer is preferably 5 μm or less and more preferably 0.1 μm or more and 2 μm or less.

In addition, various photosensitizers, antioxidants, ultraviolet absorbers, plasticizers and the like can be added to the charge generating layer, if necessary. In addition, in order that the flow of charge (carrier) is not disrupted in the charge generating layer, the charge generating layer may contain an electron transporting substance (electron-accepting substance such as acceptor).

Charge Transporting Layer

The charge transporting layer is provided on the charge generating layer.

The charge transporting layer contains the charge transporting substance and the binder resin. The charge-transporting-layer coating liquid for forming the charge transporting layer contains the first solvent and the second solvent, in addition to the charge transporting substance and the binder resin.

The ratio of the charge transporting substance to the binder resin is preferably in a range from 3:10 to 20:10 (mass ratio) and more preferably in a range from 5:10 to 15:10 (mass ratio).

The thickness of the charge transporting layer is preferably 5 μm or more and 50 μm or less, more preferably 10 μm or more and 35 μm or less and more preferably 10 μm or more and 20 μm or less.

Various additives can be added to the respective layers of the electrophotographic photosensitive member. Examples of the additive include antidegradants such as an antioxidant, an ultraviolet absorber and a light stabilizer, and fine particles such as organic fine particles and inorganic fine particles. Examples of the antidegradant include a hindered phenol-based antioxidant, a hindered amine-based light stabilizer, a sulfur atom-containing antioxidant and a phosphorus atom-containing antioxidant. Examples of the organic fine particles include polymer resin particles such as fluorine atom-containing resin particles, polystyrene fine particles and polyethylene resin particles. Examples of the inorganic fine particles include metal oxides such as silica and alumina.

When the coating liquid for each of the layers is applied, an applying method such as a dip-applying method (dip coating method), a spray coating method, a spinner coating method, a roller coating method, a Meyer bar coating method or a blade coating method can be used. In particular, a dip-applying method can be used.

The drying temperature for each of the layers can be 60° C. or higher and 150° C. or lower. The drying temperature for the charge transporting layer can be particularly 100° C. or higher and 140° C. or lower. In addition, the drying time is preferably 10 to 60 minutes and more preferably 20 to 60 minutes.

Electrophotographic Apparatus

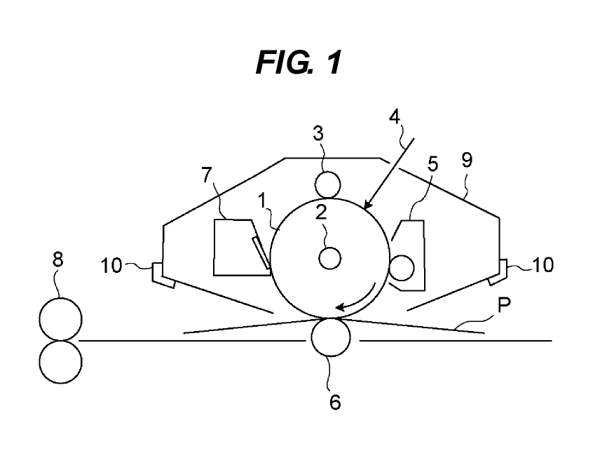

FIG. 1 illustrates one example of a schematic configuration of an electrophotographic apparatus equipped with a process cartridge having the electrophotographic photosensitive member of the present invention.

In FIG. 1, reference number 1 represents a cylindrical electrophotographic photosensitive member, and the cylindrical electrophotographic photosensitive member is rotation-driven around an axis 2 in an arrow direction at a predetermined circumferential velocity. The surface of the electrophotographic photosensitive member 1 rotation-driven is uniformly charged to a predetermined positive or negative potential by a charging device (primary charging device: charging roller or the like) 3. Then, the surface is subjected to exposure light (image exposure light) 4 intensity-modulated according to a time-series electric digital image signal of intended image information that is output from an exposure device (not illustrated) for slit exposure, laser beam scanning exposure or the like. Thus, an electrostatic latent image according to an intended image is sequentially formed on the surface of the electrophotographic photosensitive member 1.

The electrostatic latent image formed on the surface of the electrophotographic photosensitive member 1 is developed by reversal development with toner contained in a developer of a developing device 5, to form a toner image. Then, the toner image formed and carried on the surface of the electrophotographic photosensitive member 1 is sequentially transferred to a transfer material (paper or the like) P by transfer bias from a transfer device (transfer roller or the like) 6. Herein, the transfer material P is taken out of a transfer material-feeding device (not illustrated) to a portion between the electrophotographic photosensitive member 1 and the transfer device 6 (contact portion) in synchronization with the rotation of the electrophotographic photosensitive member 1, and fed. In addition, a bias voltage having a polarity opposite to the charge of the toner is applied from a bias power source (not illustrated) to the transfer device 6.

The transfer material P to which the toner image is transferred is separated from the surface of the electrophotographic photosensitive member 1, introduced to a fixing device 8 to be subjected to a treatment for fixing the toner image, and thus printed out as an image formed product (print, copy) to the outside of the apparatus.

The surface of the electrophotographic photosensitive member 1 to which the toner image has been transferred is subjected to the removal of the developer as a transfer residue (transfer residual toner) by a cleaning device (cleaning blade or the like) 7, and cleaned. Then, the surface is subjected to a discharging treatment by pre-exposure light (not illustrated) from a pre-exposure device (not illustrated), and then repeatedly used for image formation. When the charging device 3 is a contact charging device using a charging roller or the like as illustrated in FIG. 1, pre-exposure is not necessarily needed.

A plurality of components from the components such as the electrophotographic photosensitive member 1, the charging device 3, the developing device 5, the transfer device 6 and the cleaning device 7 may be selected and configured so as to be accommodated in a container and integrally supported as a process cartridge. Then, the process cartridge may be configured so as to be detachable to the main body of the electrophotographic apparatus such as a copier and a laser beam printer. In FIG. 1, the electrophotographic photosensitive member 1 is integrally supported together with the charging device 3, the developing device 5 and the cleaning device 7 to provide a cartridge. Then, the cartridge is used as a process cartridge 9 that is detachable to the main body of the electrophotographic apparatus by using a guiding device 10 such as a rail of the main body of the electrophotographic apparatus.

### EXAMPLES

Hereinafter, the present invention will be described with reference to specific Examples in more detail. However, the present invention is not limited to the Examples. Herein, “parts” in Examples means “parts by mass”.

### Example 1

An aluminum cylinder having a diameter of 24 mm and a length of 257 mm was used as a support (conductive support).

Then, 10 parts of barium sulfate coated with SnO₂ (conductive particles), 2 parts of titanium oxide (pigment for regulating resistance), 6 parts of a phenolic resin (binder resin), 0.001 parts of a silicone oil (leveling agent) and a mixed solvent of 4 parts of methanol and 16 parts of methoxy propanol were used to prepare a conductive-layer coating liquid. The conductive-layer coating liquid was dip-applied on the support, and the resulting coat was cured (thermally cured) at 140° C. for 30 minutes to thereby form a conductive layer having a thickness of 25 μm.

Then, 3 parts of N-methoxymethylated nylon and 3 parts of copolymerized nylon were dissolved in a mixed solvent of 65 parts of methanol and 30 parts of n-butanol to thereby prepare an undercoat-layer coating liquid. The undercoat-layer coating liquid was dip-applied on the conductive layer, and the resulting coat was dried at 100° C. for 10 minutes to thereby form an undercoat layer having a thickness of 0.7 μm.

Then, 10 parts of hydroxygallium phthalocyanine crystals (charge generating substance) of a crystal form having strong peaks at Bragg angles 2θ±0.2° of 7.5°, 9.9°, 16.3°, 18.6°, 25.1° and 28.3° in CuKα characteristic X-ray diffraction were added to a liquid in which 5 parts of a polyvinyl butyral resin (product name: S-Lec BX-1 produced by Sekisui Chemical Co., Ltd.) was dissolved in 250 parts of cyclohexanone, and was dispersed by a sand mill apparatus using glass beads having a diameter of 1 mm in an atmosphere at 23±3° C. for 1 hour. After the dispersing, 250 parts of ethyl acetate was added thereto to thereby prepare a charge-generating-layer coating liquid. The charge-generating-layer coating liquid was dip-applied on the undercoat layer, and the resulting coat was dried at 100° C. for 10 minutes to thereby form a charge generating layer having a thickness of 0.22 μm.

Then, 9.8 parts of the compound represented by the formula (CTM-2) as a charge transporting substance, and 12.2 parts of polyester resin A (weight average molecular weight 55000) having the structural unit represented by the formula (1-18) were dissolved in a mixed solvent of 80 parts of o-xylene (boiling point: 144° C.) and 20 parts of cyclohexanone (boiling point: 155.6° C.) to thereby prepare a charge-transporting-layer coating liquid. The charge-transporting-layer coating liquid was dip-applied on the charge generating layer, and the resulting coat was dried at 130° C. for 60 minutes to thereby form a charge transporting layer (surface layer) having a thickness of 20 μm.

Herein, solubility Y1 of CTM-2 in 100 g of o-xylene was 16 g and solubility Y2 of CTM-2 in 100 g of cyclohexanone was 12 g, thereby satisfying the expression (6).

Thus, an electrophotographic photosensitive member having the support, the conductive layer, the undercoat layer, the charge generating layer and the charge transporting layer in this order, the charge transporting layer being a surface layer, was produced.

Measurement of Concentration Gradient of Charge Transporting Substance in Charge Transporting Layer

The electrophotographic photosensitive member produced as described above was obliquely cut in the thickness direction by an ultramicrotome, and the resulting oblique plane was subjected to IR spectroscopy (IR) measurement by the μATR method. FT-IR manufactured by PerkinElmer Co., Ltd. was used for measuring an IR spectrum, the ATR crystal was Ge, the measurement pitch was about 80 μm, and the number of accumulations performed was 256. The absorption bands shown below, suitable for the types of the charge transporting substance and the resin used in the charge transporting layer, were selected from the resulting spectrum, and the change in the mass ratio of the charge transporting substance to the resin was observed from the intensity ratio of the bands. With respect to the quantitative determination method, the calibration curve method by a known standard sample was used. The results are shown in Table 2.

(CTM1) 1590 cm⁻¹
(CTM2) 1486 cm⁻¹
(CTM3) 1491 cm⁻¹
(CTM4) 1488 cm⁻¹
(CTM6) 1493 cm⁻¹
Polyester resin A having a structural unit represented by formula (1-4) 1775 cm⁻¹
Polyester resin A having a structural unit represented by formula (1-10) 1738 cm⁻¹
Polyester resin A having a structural unit represented by formula (1-18) 1734 cm⁻¹

Then, the evaluation of the electrophotographic photosensitive member produced is described.

Evaluation of Image Deletion

The electrophotographic photosensitive member produced was mounted to a process cartridge for cyan toner of LBP “Color LaserJet 3800” manufactured by Hewlett-Packard Company. Herein, an exhaust fan of the main body of Color LaserJet 3800 was removed to block an air trunk. In addition, Color LaserJet 3800 was altered so as to have a process speed of 180 mm/sec.

The evaluation apparatus thus altered was used to continuously perform a paper-feeding test in an environment at a temperature of 33° C. and a humidity of 90% RH in a repeated manner. An E-letter image of full color (4% printing for each color) was continuously printed for 5000 sheets, and the paper for feeding, used herein, was one including a loading material containing talc, which had been left to stand in advance in the above environment for 24 hours while the packaging sheet being opened, to absorb the water content. When the image deletion was determined, the full color E-letter on each of the sheets continuously fed was evaluated, and the degree of the image deletion was evaluated immediately after 5000 sheets were continuously subjected to printing and after the sheets were then left to stand for 20 hours. The indexes of the image deletion were as follows. In the present invention, it was determined that Ranks A, B and C corresponded to levels at which the effect of the present invention was achieved, and in particular, Rank A corresponded to an excellent level. On the other hand, it was determined that Ranks D and E corresponded to levels at which the effect of the present invention was not achieved. The evaluation results are shown in Table 2.

A: No image deletion occurred.

B: Image deletion slightly occurred, but did not have a large effect on E-letter.

C: Image deletion occurred, but E-letter was distinguishable.

D: Image deletion occurred, and E-letter was not distinguishable.

E: Image deletion occurred, and E-letter almost disappeared.

Evaluation of Potential Change

The evaluation apparatus altered above was used to continuously perform a paper-feeding test in an environment at a temperature of 15° C. and a humidity of 10% RH in a repeated manner. The surface potential (dark portion potential and light portion potential) of the electrophotographic photosensitive member was measured at the position of a developing device while the developing device was exchanged with a tool secured so that a probe for potential measurement was located at a position away from the end portion of the electrophotographic photosensitive member by 130 mm. The dark portion potential (VD) of the unexposed part of the electrophotographic photosensitive member was set to −600V, and by irradiating with laser light, the light portion potential (VL1) after light attenuation from the dark portion potential (VD) was measured. In addition, A4 size plain paper was used and 10000 sheets of images were continuously output, and the light portion potential (VL2) was again measured to evaluate the variation in the light portion potential (ΔVL=|VL1−VL2|) before and after 10000 sheets of solid black images were output. The results are shown in Table 2.

### Examples 2 to 6

Each of electrophotographic photosensitive members was produced in the same manner as in Example 1 except that the charge transporting substance represented by the formula (CTM-2), polyester resin A having the structural unit represented by the formula (1-18) and o-xylene in Example 1 were changed as shown in Table 1. The evaluation results are shown in Table 2. Herein, each solubility Y1(g) and each solubility Y2(g) are shown in Table 1.

### Examples 7 to 9

Each of electrophotographic photosensitive members was produced in the same manner as in Example 1 except that in Example 1, 80 parts of o-xylene was changed to 60 parts of o-xylene, 20 parts of tetrahydrofuran was further added, and the second solvent was changed as shown in Table 1. The evaluation results are shown in Table 2. Herein, each solubility Y1(g) and each solubility Y2(g) are shown in Table 1.

### Examples 10 to 12

Each of electrophotographic photosensitive members was produced in the same manner as in Example 7 except that in Example 7, CTM-2 was changed to CTM-3 and the second solvent was changed as shown in Table 1. The evaluation results are shown in Table 2. Herein, each solubility Y1(g) and each solubility Y2(g) are shown in Table 1.

TABLE 1

| | Charge transporting | | First | | | Solubility | Solubility |
|---|---|---|---|---|---|---|---|
| Example | substance | Resin | solvent | Second solvent | Other solvent | Y1 | Y2 |
| 1 | CTM-2 | (1-18) | o-Xylene | Cyclohexanone | — | 16 | 12 |
| 2 | CTM-2 | (1-18) | Toluene | Cyclohexanone | — | 20 | 12 |
| 3 | CTM-2 | (1-4) | o-Xylene | Cyclohexanone | — | 16 | 12 |
| 4 | CTM-3 | (1-18) | o-Xylene | Cyclohexanone | — | 20 | 14 |
| 5 | CTM-3 | (1-18) | Toluene | Cyclohexanone | — | 25 | 14 |
| 6 | CTM-3 | (1-4) | o-Xylene | Cyclohexanone | — | 20 | 14 |
| 7 | CTM-2 | (1-18) | o-Xylene | Acetophenone | Tetrahydrofuran | 16 | 8 |
| 8 | CTM-2 | (1-18) | o-Xylene | Benzyl acetate | Tetrahydrofuran | 16 | 12 |
| 9 | CTM-2 | (1-18) | o-Xylene | Methyl | Tetrahydrofuran | 16 | 8 |
| | | | | benzoate | | | |
| 10 | CTM-3 | (1-18) | o-Xylene | Acetophenone | Tetrahydrofuran | 20 | 10 |
| 11 | CTM-3 | (1-18) | o-Xylene | Benzyl acetate | Tetrahydrofuran | 20 | 14 |
| 12 | CTM-3 | (1-18) | o-Xylene | Methyl | Tetrahydrofuran | 20 | 10 |
| | | | | benzoate | | | |

### Example 13

The same manner as in Example 1 was performed until the charge generating layer was formed. Then, a charge-transporting-layer coating liquid in which 13 parts of CTM-2 as the charge transporting substance, 9 parts of the polyester resin having the structural unit represented by the formula (1-18) and 100 parts of o-xylene were mixed was dip-applied on the charge generating layer to form a coat. The resulting coat was naturally dried to form a first charge transporting layer having a thickness of 10 μm.

Then, a charge-transporting-layer coating liquid in which 22 parts of the polyester resin having the structural unit represented by the formula (1-18) and 100 parts of o-xylene were mixed was dip-applied on the first charge transporting layer to form a coat. The resulting coat was naturally dried to form a second charge transporting layer having a thickness of 10 μm.

Furthermore, the resultant was subjected to an annealing treatment at 130° C. for 20 minutes to allow the interface between the first charge transporting layer and the second charge transporting layer not to be present to form a charge transporting layer of one layer, thereby producing an electrophotographic photosensitive member. The evaluation results are shown in Table 2.

### Example 14

An electrophotographic photosensitive member was produced in the same manner as in Example 13 except that the charge transporting substance in Example 13 was changed to CTM-3. The evaluation results are shown in Table 2.

TABLE 2

| | | | | | | | | | | Image deletion | | |
|---|---|---|---|---|---|---|---|---|---|---|---|---|
| | | | | | | | | | | | 20 | |
| | | | | | | | | | | | hours | |
| | | | | | | | | | | | after | Variation |
| | Ratio of charge | | | | | | | | | Immediately | feeding | in light |
| | transporting substance/resin (distance (μm) | | | | | (X_{Pm+1} − X_{Pm})/ | | | | after | for | portion |
| | from surface in depth direction) | | | | | (mT/5 − (m − 1)T/5) | | | | feeding for | 5000 | potential |
| Example | X_{P1}(0) | X_{P2}(4) | X_{P3}(8) | X_{P4}(12) | X_{P5}(16) | P2-P1 | P3-P2 | P4-P3 | P5-P4 | 5000 sheets | sheets | (V) |
| 1 | 0.65 | 0.70 | 0.77 | 0.82 | 0.90 | 0.013 | 0.018 | 0.013 | 0.020 | B | B | 15 |
| 2 | 0.66 | 0.72 | 0.76 | 0.82 | 0.90 | 0.015 | 0.010 | 0.015 | 0.020 | B | B | 15 |
| 3 | 0.65 | 0.71 | 0.76 | 0.83 | 0.90 | 0.015 | 0.013 | 0.018 | 0.018 | A | A | 25 |
| 4 | 0.65 | 0.71 | 0.76 | 0.84 | 0.88 | 0.015 | 0.013 | 0.020 | 0.010 | B | B | 15 |
| 5 | 0.66 | 0.71 | 0.76 | 0.84 | 0.89 | 0.013 | 0.013 | 0.020 | 0.013 | B | B | 15 |
| 6 | 0.65 | 0.71 | 0.78 | 0.82 | 0.89 | 0.015 | 0.018 | 0.010 | 0.018 | A | A | 25 |
| 7 | 0.42 | 0.53 | 0.72 | 0.88 | 1.01 | 0.028 | 0.048 | 0.040 | 0.033 | A | A | 10 |
| 8 | 0.41 | 0.56 | 0.73 | 0.88 | 1.04 | 0.038 | 0.043 | 0.038 | 0.040 | A | A | 10 |
| 9 | 0.41 | 0.57 | 0.73 | 0.87 | 1.04 | 0.040 | 0.040 | 0.035 | 0.043 | A | A | 10 |
| 10 | 0.39 | 0.57 | 0.72 | 0.87 | 1.02 | 0.045 | 0.038 | 0.038 | 0.038 | A | A | 10 |
| 11 | 0.40 | 0.55 | 0.71 | 0.89 | 1.02 | 0.038 | 0.040 | 0.045 | 0.033 | A | A | 10 |
| 12 | 0.40 | 0.56 | 0.71 | 0.89 | 1.05 | 0.040 | 0.038 | 0.045 | 0.040 | A | A | 10 |
| 13 | 0.38 | 0.44 | 0.55 | 0.82 | 1.03 | 0.015 | 0.028 | 0.068 | 0.053 | B | C | 40 |
| 14 | 0.39 | 0.45 | 0.55 | 0.83 | 1.03 | 0.015 | 0.025 | 0.070 | 0.050 | B | C | 40 |

### Comparative Example 1

An electrophotographic photosensitive member was produced in the same manner as in Example 1 except that in Example 1, 80 parts of o-xylene was changed to 100 parts of o-xylene and cyclohexanone was not added. The evaluation results are shown in Table 3.

### Comparative Example 2

An electrophotographic photosensitive member was produced in the same manner as in Example 3 except that in Example 3, 80 parts of o-xylene was changed to 100 parts of o-xylene and cyclohexanone was not added. The evaluation results are shown in Table 3.

### Comparative Example 3

An electrophotographic photosensitive member was produced in the same manner as in Example 4 except that in Example 4, 80 parts of o-xylene was changed to 100 parts of o-xylene and cyclohexanone was not added. The evaluation results are shown in Table 3.

### Comparative Example 4

An electrophotographic photosensitive member was produced in the same manner as in Example 6 except that in Example 6, 80 parts of o-xylene was changed to 100 parts of o-xylene and cyclohexanone was not added. The evaluation results are shown in Table 3.

### Comparative Example 5

An electrophotographic photosensitive member was produced in the same manner as in Example 1 except that CTM-2 in Example 1 was changed to CTM-1 represented by the following formula. The evaluation results are shown in Table 3.

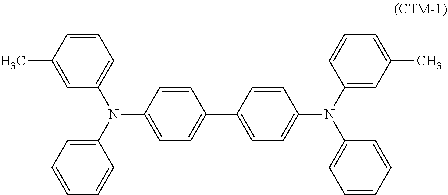

TABLE 3

| | | | | | | | | | | Image deletion | | |
|---|---|---|---|---|---|---|---|---|---|---|---|---|
| | | | | | | | | | | | 20 | |
| | | | | | | | | | | | hours | |
| | | | | | | | | | | | after | Variation |
| | Ratio of charge | | | | | | | | | Immediately | feeding | in light |
| | transporting substance/resin (distance (μm) | | | | | (X_{Pm+1} − X_{Pm})/ | | | | after | for | portion |
| Comparative | from surface in depth direction) | | | | | (mT/5 − (m − 1)T/5) | | | | feeding for | 5000 | potential |
| Example | X_{P1}(0) | X_{P2}(4) | X_{P3}(8) | X_{P4}(12) | X_{P5}(16) | P2-P1 | P3-P2 | P4-P3 | P5-P4 | 5000 sheets | sheets | (V) |
| 1 | 0.78 | 0.82 | 0.82 | 0.78 | 0.80 | 0.010 | 0.000 | −0.010 | 0.005 | D | E | 45 |
| 2 | 0.79 | 0.79 | 0.83 | 0.80 | 0.81 | 0.000 | 0.010 | −0.007 | 0.003 | C | D | 55 |
| 3 | 0.78 | 0.81 | 0.80 | 0.78 | 0.82 | 0.008 | −0.003 | −0.005 | 0.010 | D | E | 45 |
| 4 | 0.78 | 0.79 | 0.78 | 0.82 | 0.80 | 0.003 | −0.003 | 0.010 | −0.005 | C | D | 55 |
| 5 | 0.70 | 0.73 | 0.77 | 0.81 | 0.85 | 0.008 | 0.010 | 0.010 | 0.010 | D | D | 25 |

In Tables 2 and 3, with respect to “(X_{Pm+1}−X_{Pm})/(mT/5−(m−1)T/5)”, the values when m=1 (the expression (5-1)) are shown in the column of P2−P1, the values when m=2 (the expression (5-2)) are shown in the column of P3−P2, the values when m=3 (the expression (5-3)) are shown in the column of P4−P3, and the values when m=4 (the expression (5-4)) are shown in the column of P5−P4.

It is found from Examples 1 to 14 that the electrophotographic photosensitive member of the present invention simultaneously suppresses image deletion in a high-temperature and high-humidity environment and potential change in low-temperature and low-humidity environment.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-013510, filed Jan. 28, 2013, and Japanese Patent Application No. 2014-004387, filed Jan. 14, 2014, which are hereby incorporated by reference herein in their entirety.

What is claimed is:

1. An electrophotographic photosensitive member comprising:
a support;
a charge generating layer formed on the support; and
a charge transporting layer formed on the charge generating layer;
wherein
the charge transporting layer is a surface layer of the electrophotographic photosensitive member,
the charge transporting layer comprises:
at least one charge transporting substance selected from the group consisting of a compound represented by the following formula (2) and a compound represented by the following formula (3); and
at least one binder resin selected from the group consisting of a polycarbonate resin having a structural unit represented by the following formula (IA) and a polyester resin having a structural unit represented by the following formula (IB); and
the charge transporting layer satisfies the following expression (4-1):
X_{P1}<X_{P5} (4-1)
wherein,
X_{P1} represents the mass ratio (D/B) of the charge transporting substance (D) to the binder resin (B) based on IR spectroscopy measured at P1,
X_{P5} represents the mass ratio (D/B) of the charge transporting substance (D) to the binder resin (B) based on IR spectroscopy measured at P5,
P1 is the position on the surface of the charge transporting layer, and
P5 is the position where the distance from the surface of the charge transporting layer is 4T/5 when the thickness of the charge transporting layer is designated as T; 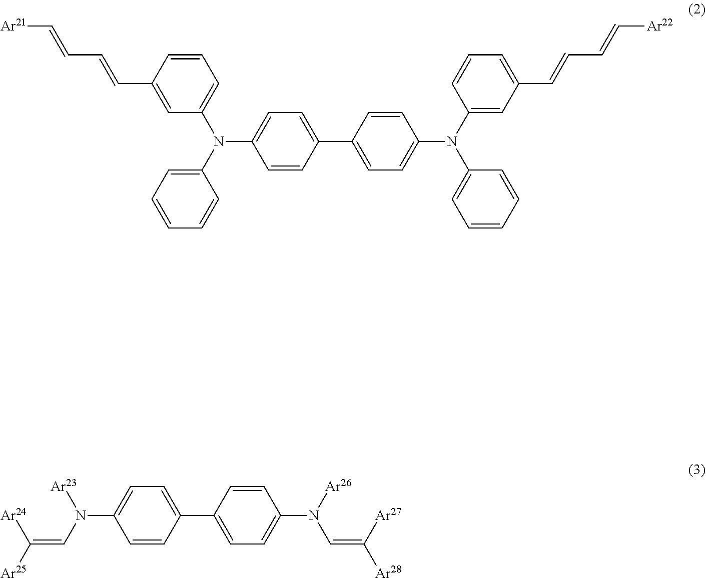
wherein,
Ar²¹ and Ar²² each independently represent a phenyl group or a phenyl group substituted with a methyl group, and
Ar²³ to Ar²⁸ each independently represent a phenyl group or a phenyl group substituted with a methyl group; 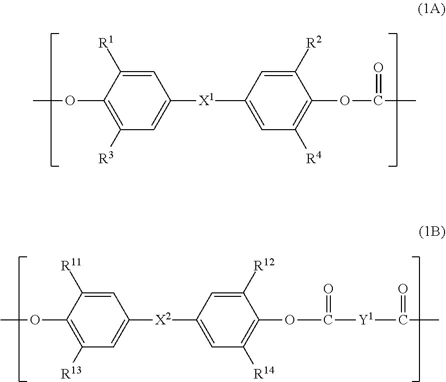
wherein,
R¹ to R⁴ each independently represent a hydrogen atom, a methyl group or a phenyl group,
X¹ represents a single bond, an oxygen atom, a cyclohexylidene group or a bivalent group represented by the following formula (A),
R¹¹ to R¹⁴ each independently represent a hydrogen atom, a methyl group or a phenyl group,
X² represents a single bond, an oxygen atom, a cyclohexylidene group or a bivalent group represented by the following formula (A), and
Y¹ represents a meta-phenylene group, a para-phenylene group, a cyclohexylene group or a bivalent group represented by the following formula (B); and 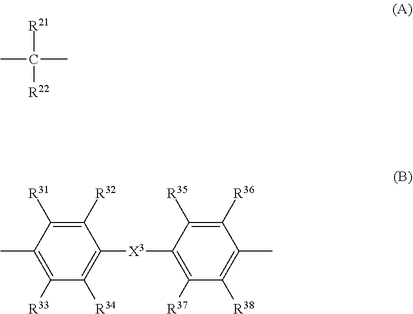
wherein,
R²¹ and R²² each independently represent a hydrogen atom, a methyl group, an ethyl group or a phenyl group,
R³¹ to R³⁸ each independently represent a hydrogen atom, a methyl group or a phenyl group, and
X³ represents a single bond, an oxygen atom, a sulfur atom or a methylene group.

2. The electrophotographic photosensitive member according to claim 1,
wherein the charge transporting layer satisfies the following expressions (4-2) to (4-5):
X_{P1}<X_{P2} (4-2)
X_{P2}<X_{P3} (4-3)
X_{P3}<X_{P4} (4-4)
X_{P4}<X_{P5} (4-5)
wherein,
X_{P2} represents the mass ratio (D/B) of the charge transporting substance (D) to the binder resin (B) based on IR spectroscopy measured at P2,
X_{P3} represents the mass ratio (D/B) of the charge transporting substance (D) to the binder resin (B) based on IR spectroscopy measured at P3,
X_{P4} represents the mass ratio (D/B) of the charge transporting substance (D) to the binder resin (B) based on IR spectroscopy measured at P4,
P2 is the position where the distance from the surface of the charge transporting layer is T/5 when the thickness of the charge transporting layer is designated as T,
P3 is the position where the distance from the surface of the charge transporting layer is 2T/5 when the thickness of the charge transporting layer is designated as T, and
P4 is the position where the distance from the surface of the charge transporting layer is 3T/5 when the thickness of the charge transporting layer is designated as T.

3. The electrophotographic photosensitive member according to claim 2,
wherein the charge transporting layer further satisfies the following expression (5):
0.020≦(X_{Pm+1}−X_{Pm})/(mT/5−(m−1)T/5)≦0.060 (5)
wherein, m is an integer of 1 to 4.

4. The electrophotographic photosensitive member according to claim 1, wherein the charge transporting substance is the compound represented by the formula (3).

5. The electrophotographic photosensitive member according to claim 1, wherein the thickness of the charge transporting layer is 10 μm or more and 35 μm or less.

6. The electrophotographic photosensitive member according to claim 1, wherein the charge transporting substance is a compound represented by the following formula (CTM-2) or (CTM-3).

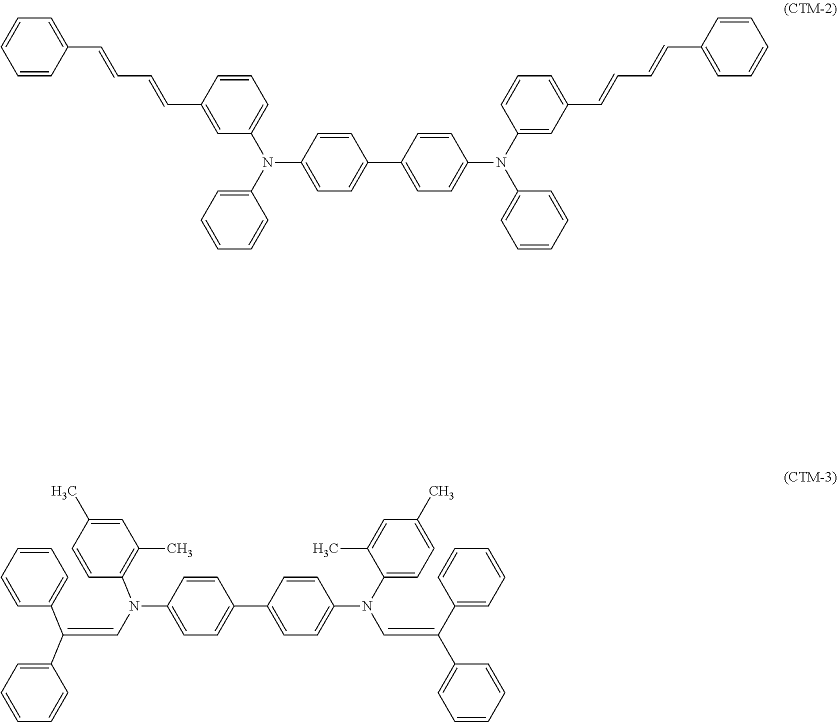 [SMILES: C(/C=C/c1cccc(N(c2ccccc2)c2ccc(-c3ccc(N(c4ccccc4)c4cccc(/C=C/C=C/c5ccccc5)c4)cc3)cc2)c1)=C\c1ccccc1 ; Cc1ccc(N(C=C(c2ccccc2)c2ccccc2)c2ccc(-c3ccc(N(C=C(c4ccccc4)c4ccccc4)c4ccc(C)cc4C)cc3)cc2)c(C)c1]

7. A process cartridge detachably attachable to a main body of an electrophotographic apparatus, wherein the process cartridge integrally supports:
the electrophotographic photosensitive member according to claim 1, and
at least one device selected from the group consisting of a charging device, a developing device, a transferring device and a cleaning device.

8. An electrophotographic apparatus comprising an electrophotographic photosensitive member according to claim 1, a charging device, an exposure device, a developing device and a transfer device.
